(19) United States
(12) Patent Application Publication
(10) Pub. No.: US 2004/0213459 A1
(43) Pub. Date: Oct. 28, 2004

(54) Multispectral photographed image analyzing apparatus

(76) Inventors: Nobuhiro Ishimaru, Tokyo (JP); Kazuaki Iwamura, Nishitokyo (JP); Norio Tanaka, Hitachi (JP)

Correspondence Address: REED SMITH LLP, Suite 1400, 3110 Fairview Park Drive, Falls Church, VA, 22042, US

(21) Appl. No.: 10/806,129

(22) Filed: Mar. 23, 2004

(30) Foreign Application Priority Data
Mar. 28, 2003 (JP) 2003-089690

(51) Int. Cl. G06K 9/46

(52) U.S. Cl. 382/191

(57) ABSTRACT

Disclosed here is a system for creating maps using multispectral landscape photographed images. The system comprises surface substance analyzing means for analyzing a multispectral landscape photographed image using a spectral information database, on-ground object identifying/analyzing means for identifying an on-ground object using the surface substance analytical result and the on-ground object information database; and outputting means for outputting map information according to the on-ground object identification/analytical result and output setting.

### CLAIM OF PRIORITY

The present application claims priority from Japanese application JP 2003-089690 filed on Mar. 28, 2003, the content of which is hereby incorporated by reference into this application.

### FIELD OF THE INVENTION

The present invention relates to a system for analyzing images photographed from man-made satellites and airplanes with use of a computer to extract necessary information, more particularly to a method and system for creating a map from multispectral photographed images obtained by observing a plurality of wavelength bands.

### BACKGROUND OF THE INVENTION

In recent years, high wavelength resolution optical sensors have been put in practical use to enable the use of multispectral photographed landscape images obtained by observing a plurality of wavelength bands from the sky using airplanes and man-made satellites. Those sensors are featured by high spectral characteristics achieved by the improvement of sensor techniques. The sensors can handle a high band width ranged from several nano to several tens of nano orders. For example, they can handle multispectral image information to be collected in a range from several bands to several tens of bands, hyper spectral image information to be collected in a range of several hundreds of bands, and ultra spectral image information to be collected in a range of a thousand bands. Consequently, it has come to be possible to obtain spectral information (signature) denoting spectral characteristics specific to substances in each pixel, thereby obtaining detailed information of the quality of the surface of the earth. Conventional techniques that have employed aerial photos typically have usually read shape information of target on-ground objects. This is why the conventional techniques have been difficult to read such on-ground objects unless otherwise they are photographed over several pixels to more than several tens of pixels. In multispectral landscape photographed images, however, the spectral analysis has made it possible to identify even a small on-ground object in a pixel and/or a sub-pixel (part of a pixel) through a spectral analysis, which has been impossible, thereby the new method is expected to be able to recognize the circumstances of the target area more in detail.

However, such a multispectral image requires observation of so many bands, that the user has been difficult to recognize every data without omission when attempting to read it visually. In addition, because the amount of data of such a multispectral image becomes large in proportional to the number of bands to be observed, it has been difficult to handle such mass data. To solve those conventional problems, there has been proposed some methods so far and a spectral analysis is one of them. The spectral analysis uses a spectral library in which spectral information of various substances is collected as a database so as to obtain necessary information from multispectral landscape photographed images efficiently. In other words, the spectral library is used so that spectral information registered in it so as to correspond to each surface substance name is collated with an image spectrum observed on each multispectral landscape photographed image to identify the surface substance photographed on the image and/or list up candidate surface substances in order of possibility to be the target. Spectral similarity that denotes a coincidence degree between spectral shapes by such a value as 0, 1, etc. may be used for the spectral collation. As a result, the similarity degree between spectra is evaluated quantitatively, thereby the spectral information most similar to the target spectrum in the library is searched to identify the photographed substance on the image.

There is another method that uses a conventional technique for obtaining land coverage information through the above described spectral analysis (ex., refer to the patent document 1). Hereunder, a description will be made for an example of the conventional technique that uses the spectra similarity as described above with reference to FIGS. 21A and 21B. FIG. 21A shows an illustration for describing a surface substance analysis according to the conventional technique. According to the conventional technique, a surface substance analysis 2103 is made by spectral collation between an image spectrum 2102 obtained from a specified position (one pixel) 2101 on a vector landscape photographed image 2100 with those in a spectra library to search two items of spectral information similar to the image spectrum 2102 and display the coniferous tree spectrum 2104 most similar to the obtained image spectrum 2102 with a solid line and the concrete spectrum 2105 of the next similarity with a dotted line. It would be understood from this example that the surface substance is identified even when the on-ground object is as small as a pixel to obtain effective data for mapping. FIG. 21B shows an illustration for describing how to create a land coverage classification map through a surface substance analysis according to the conventional technique. The surface substance analysis is executed for all over the image 2110 (step 2111) and the analytical result is employed to identify the target surface substance (step 2112) and output the data in colors to create a land coverage classification map 2113.

If such components as a plurality of lots and on-ground objects are mixed in a range equivalent to one pixel on an image, the pixel is referred to as a mixel. Generally, a wavelength resolution and a space resolution are related to each other in a trade-off relationship and the resolution of a multispectral photographed image often is medium to low. Consequently, an on-ground object is often observed as a mixel and accordingly, how to handle minute areas becomes important. The mixel spectrum becomes a mixed one in which spectra of various substances are mixed up. Therefore, in the case of simple spectral collation as described above, the results might not always be proper. It is thus required to subject their spectra to a spectrum decomposing process to estimate each component and its composition ratio. In that case, the composition ratio is used instead of the spectral similarity to enable the same calculation as the above spectral analysis. For example, if the spectral analysis is applied to the example of the surface substance analysis according to the conventional technique in FIG. 21A, the surface substance analysis (step 2103) can obtain two image spectral components and the composition ratio of each of the components with respect to the other. As a result, the highest composition ratio goes to the coniferous tree spectrum 2104 denoted as < >< >% and the next high component rate goes to the concrete spectrum 2105 denoted as ΔΔ%. Similarly, in the land coverage classification map creation process through the surface substance analysis according to the conventional technique in FIG. 21B, the component having the highest composition ratio obtained through a surface substance analysis (step 2112) is employed to identify a target surface substance (step 2112).

[Patent Document 1] JP-A No.251052/2000

It is true that land coverage classification maps are obtained now according to the conventional techniques described above so as to determine land coverage circumstances and surface substances in a target area. However, it is still impossible to obtain high order information described in general maps, such as “on-ground objects” consisting of a plurality of surface substances combined under complicated circumstances. Therefore, the analytical results cannot be used as map information as are. This has also been another conventional problem. In other words, while valuable information that cannot be found in any other data is obtained from multispectral landscape photographed images, they do not satisfy users' demands yet.

### SUMMARY OF THE INVENTION

Under such circumstances, it is an object of the present invention to provide a system for creating detailed maps that describe on-ground object level information efficiently with use of information of surface substances obtained from multispectral landscape photographed images to solve the above conventional problems.

In order to achieve the above object, the multispectral landscape photographed image analyzing system of the present invention comprises a spectral information database for storing a plurality of spectral information items, an on-ground object information database in which spectral information is stored so as to correspond to each on-ground object, means for analyzing each surface substance photographed on a multispectral landscape photographed image obtained by observing a plurality of wavelength bands from the sky, means for identifying the on-ground object photographed on the image with use of a surface substance analytical result and the on-ground object information, and means for outputting an analytical result. Consequently, the system can identify the on-ground object to be used as a fundamental component of mapping.

### BRIEF DESCRIPTION OF THE DRAWINGS

FIG. 1 is a functional block diagram of a system in an embodiment of the present invention;

FIG. 2 is a processing flow of the system in the embodiment of the present invention;

FIG. 3 is a structure of an on-ground object information database in the embodiment of the present invention;

FIG. 4 is a flowchart of an on-ground object identification/analysis in the embodiment of the present invention;

FIGS. 5A, 5B, 5C, and 5D are illustrations for describing how to combine a plurality of surface substance information items in the embodiment of the present invention;

FIGS. 6A and 6B are illustrations for describing how to make synthetic determination in an on-ground object identification/analysis in the embodiment of the present invention;

FIGS. 7A, 7B, and 7C are formats usable for outputting a map in the embodiment of the present invention;

FIG. 8 is an example of setting an output at each reduced scale in the embodiment of the present invention;

FIG. 9 is an example of a spectral library selection GUI used in the embodiment of the present invention;

FIG. 10 is an on-ground object/spectral information registration GUI used in the embodiment of the present invention;

FIG. 11 is an example of an on-ground information parameter setting GUI used in the embodiment of the present invention;

FIG. 12 is an example of an on-ground object information components combination GUI used in the embodiment of the present-invention;

FIGS. 13A and 13B are examples of a target object emphasis setting GUI used in the embodiment of the present invention;

FIGS. 14A, 14B, and 14C are examples of a target object confirmation/correction GUI used in the embodiment of the present invention;

FIG. 15 is an example of interlocked updating of on-ground object information in the embodiment of the present invention;

FIG. 16 is an example of a surface substance analysis in the embodiment of the present invention;

FIG. 17 is an example of a heterogeneous data combination in the embodiment of the present invention;

FIG. 18 is an example of automatic creation of an optimized recognition program in the embodiment of the present invention;

FIGS. 19A and 19B are examples of an analytical result output in the embodiment of the present invention;

FIG. 20 is a block diagram of a system in the embodiment of the present invention; and

FIGS. 21A and 21B are examples of a surface substance analysis according to a conventional technique.

### DETAILED DESCRIPTION OF THE PREFERRED EMBODIMENT

Hereunder, a preferred embodiment of the present invention will be described in detail with reference to the accompanying drawings. Although spectral similarity is used mainly in this preferred embodiment, the present invention is not limited only to the embodiment. It is also possible to use various other spectral analytical techniques such as a composition ratio to be found through spectrum decomposing, of course.

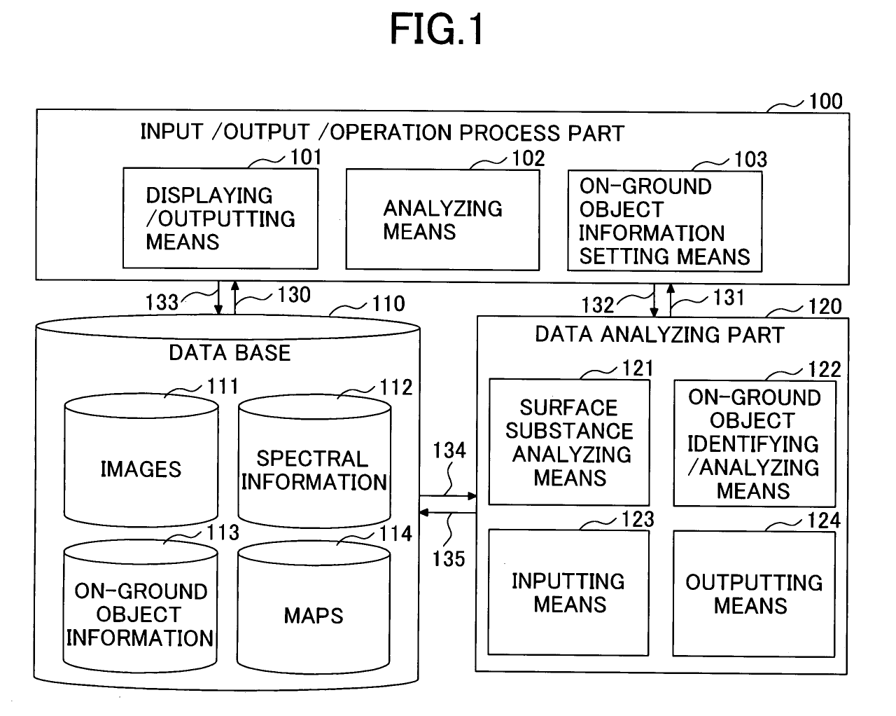

Hereinafter, an “on-ground object” will mean a component of a map, such as a road, a building, or the like, while a “surface substance” will mean a material substance, such as metal, asphalt, etc. contained in such an on-ground object. FIG. 1 shows a functional block diagram of a multispectral landscape photographed image analyzing system in an embodiment of the present invention. The system includes three functions to be realized by an input/output/operation process part 100, a database 110, and a data analyzing part 120. The input/output/operation process part 100 is configured by a displaying/outputting means 101 for displaying or outputting data and analytical results, analyzing means 102 for accepting analytical operations by the user, and an on-ground information setting means 103 for registering on-ground object information (to be described later) and setting the use of the information. The database 110 includes image data 111 such as multispectral landscape photographed images to be analyzed, spectral information data 112 such as that stored in a spectral library, etc., on-ground object information data 113 generated and used in this system, and map data 114 that is analytical teacher data or output results. The data analyzing part 120 is configured by an input means 123 for obtaining various data, outputting means 124 for outputting analytical results in various data formats, surface substance analyzing means 121 for analyzing surface substances photographed on multispectral landscape photographed images, and on-ground object identifying/analyzing means 122 for identifying each on-ground object by putting analytical results obtained by the surface substance analyzing means together. Those three functions are combined to create maps. In other words, the input/output/operation process part outputs data 130 and/or analytical result 131 to provide the user with proper information and analyzes data (step 132) and register data (step 133) according to the information inputted by the user. The data analyzing part obtains data 134 from a database to make a synthetic analysis and updates the database by feeding back analytical results to the database.

Each of the functions may be executed by a program read into a computer or the like or by hardware. Each of the functions may also be realized by a combination of software and hardware. Although the system has been described as a stand-along one, each of the functions may be realized as a distributed system. For example, the distributed system may be a client server system that assumes the input/output/operation process part as a client terminal, as well as the database and the data analyzing part as an integrated server. The distributed system-may also be a web system configured by web application programs and a web server. Although the system of the present invention analyzes data stored in a database in the above description, the system may also receive and use data obtained directly through a network and media without obtaining the data from any database.

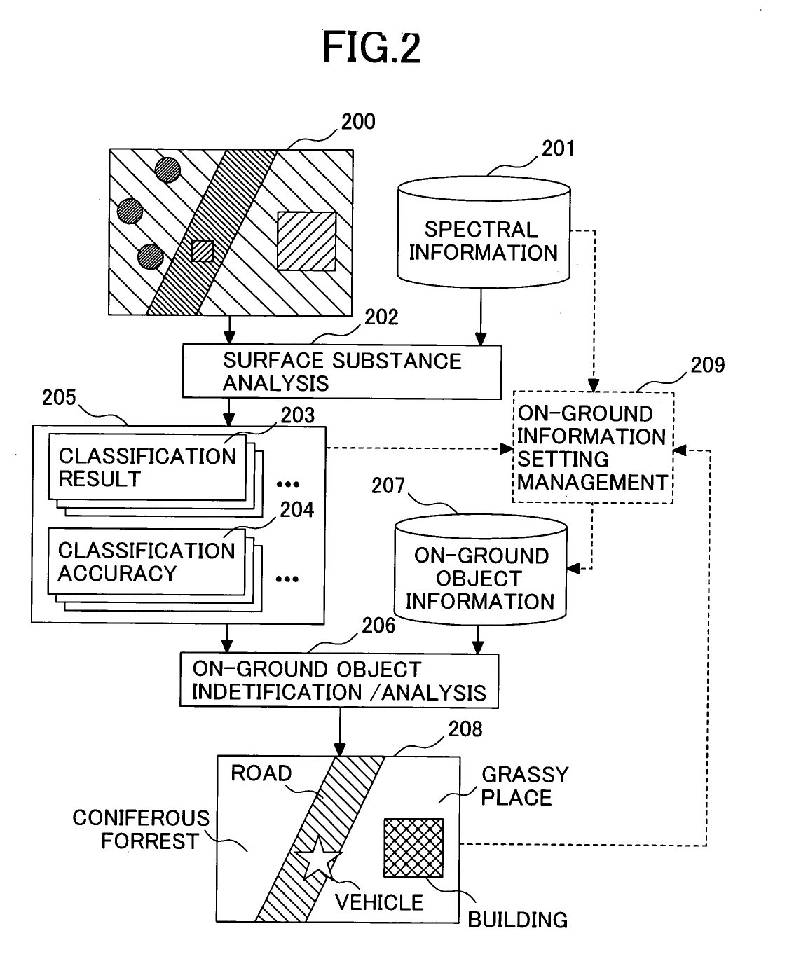

FIG. 2 shows a flowchart of the processes of the system in the embodiment of the present invention. At first, a surface substance analysis 202 is made using spectral information 201 that corresponds to each of surface substances existing all over a multispectral landscape photographed image 200 to output an analytical result 205 consisting of a classification result 203 and a classification accuracy 204. The classification result 203 consists of the name of a surface substance, etc. identified through a surface substance analysis while the classification accuracy 204 consists of such an index value as a similarity between spectra, which denotes accuracy of the classification in the surface substance analysis. If a plurality of analytical results 205 are obtained from an object area, a plurality of classification results 205 are managed so as to correspond to its classification accuracy 204 and used for the synthetic combination determination in the on-ground object identification/analysis 206 to be described later. In the on-ground object analysis 206, the classification result in every area is collated with the on-ground object information 207 to be described later. The result is employed if it matches with the feature of the on-ground object information to identify the area as the target on-ground object. Concretely, such on-ground object information is stores as information (to be described later) related to its components, that is, surface substances, etc. Such on-ground object information is used for synthetic determination (to be described later) that includes recognition of a combination, determination of a shape, determination of circumstances, etc. If no matching is found in the collation, the area is determined as an unknown on-ground object and the information of the unknown on-ground object is stored and a surface substance, which is the most possible classification result, is output as the analytical result of the area. In the processing flow, therefore, detailed and highly visually recognizable map 208 is created. And, the on-ground object information can be added/updated as needed by the on-ground information setting management means 209. Both spectral information 201 and analytical result 205 can also be referred to and data in the output map 208 can be fed back to build an accurate on-ground object information database.

Although analytical results are output as map data in this embodiment, as to be described later, various synthetic determinations are possible in on-ground object identification/analysis and map output processes to enable map information outputs such as symbolizing and full-drawing of each target object in accordance with a selected reduced scale, which cannot be obtained from any simple image processing. Although maps are output in various formats, those output maps can be used as image maps displayed in colors on images in the raster format, vector maps that output obtained results as vector and symbol data, etc., as well as image and vector combined maps in which on-ground object vector information is superposed on each image, etc. On-ground object information may also include processing parameters other than vector information so that the information can be used to identify/analyze an on-ground object. A plurality of classification results obtained from the above-described surface substance analysis may be retained until such a timing as the next analysis instruction input or the like. Consequently, existing classification results are used again to realize fast re-outputs in response to such user input operations as an on-ground object information setting change. In other words, the frequency of the surface substance analysis that increases the calculation cost is suppressed, thereby on-ground information setting changes are output immediately. Parameter adjustment work required to correct errors in the on-ground object information setting can thus be made efficiently, thereby the working environment is improved.

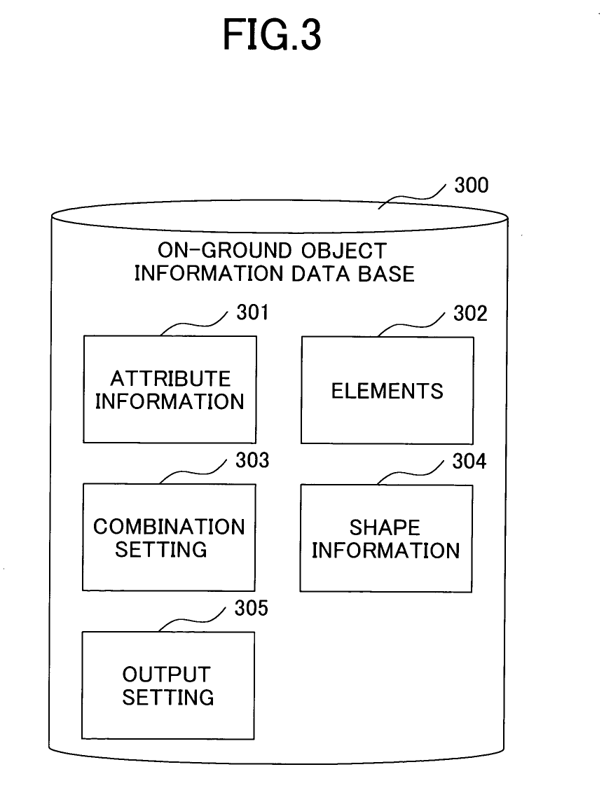

FIG. 3 is a structure of an on-ground object information database in the embodiment of the present invention. In the present invention, an on-ground object information database 300 structured as described below is used, since each on-ground object is identified by putting various information items together. Attribute information 301 consists of such items of on-ground object name, large classification group, small classification group, data type, data registering organization, data registering person, and on-ground information. The attribute information 301 may also include information about photographed place/condition, etc. of each image, which are used to set the subject on-ground object information. Those items are used as key information for sorting on-ground objects and searching a specified on-ground object in a GUI to be described later. The component 302 is information related to surface substances of each on-ground object and/or another on-ground object information. The component 302 is used to manage spectral information of a target on-ground substance and/or information of reference to another on-ground information. For example, the on-ground object information of a vehicle retains reference to the spectral information of metal so as to enable searching of a vehicle as an on-ground object candidate if metal is detected in a surface substance analysis. The combination setting 303 is information for setting a combination for recognizing a combination of on-ground objects and/or setting circumstances, etc. for determining such circumstances as an adjacent relationship. The shape information 304 is such information as each on-ground object size parameter, a template, etc. used to determine a shape of a target on-ground object. Those information items are registered and managed using an on-ground object information parameter setting GUI 1100, a component combination setting GUI 1200, etc. The output setting 305 is such information as each reduced scale output setting and emphasis setting, etc. used for outputting on-ground objects. Such an on-ground object analysis that uses those on-ground information items makes it possible to recognize high-order recognition such as identifying an on-ground object from information of surface substances photographed on an image. Information related to an on-ground object existing place may also be stored as information of the output setting 305.

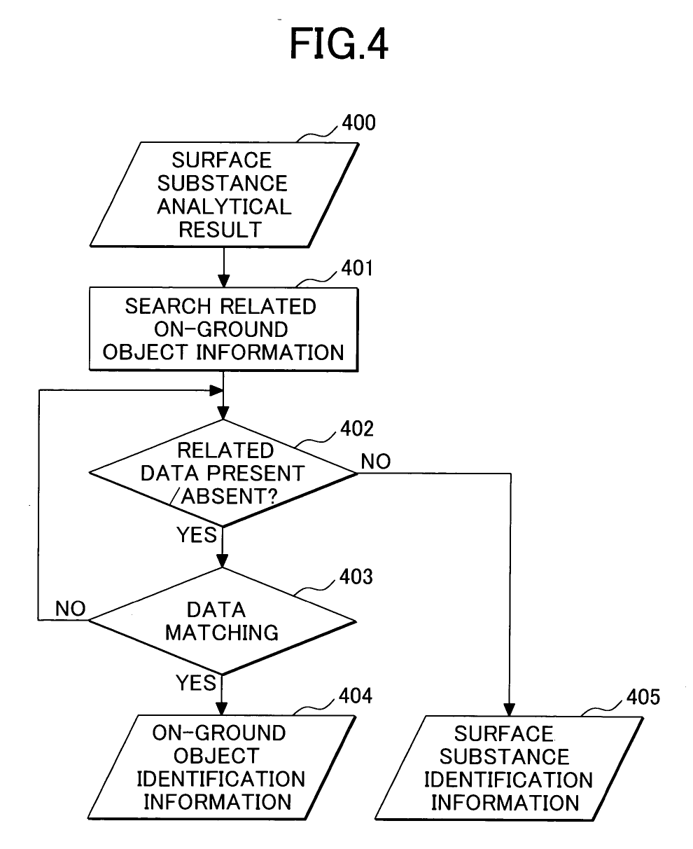

FIG. 4 is a flowchart of an on-ground object identification/analysis performed in the embodiment of the present invention. In the present invention, a surface substance analytical result of a multispectral landscape photographed image and the above described on-ground object information database 300 are used to identify a target on-ground object according to the schematic flowchart shown in FIG. 4. In other words, according to the surface substance analytical result 400 of a target area, its related on-ground object information is searched (step 401). For example, the target information is searched in the on-ground object information database according to key information that may be an on-ground object that includes a target surface substance or a group included in such a large classification group as vegetation and a man-made object, which includes a target surface substance. And, according to the search result, whether or not any related data exists is determined (step 402). If there is no related information, the surface substance is employed and it is output as surface substance identification information 405. If there is any related information, whether both data items match (step 403) is determined. If both data match, the on-ground object information 404 is output as the target on-ground object. If there is no related information, a message may be output to denote that the data is not found.

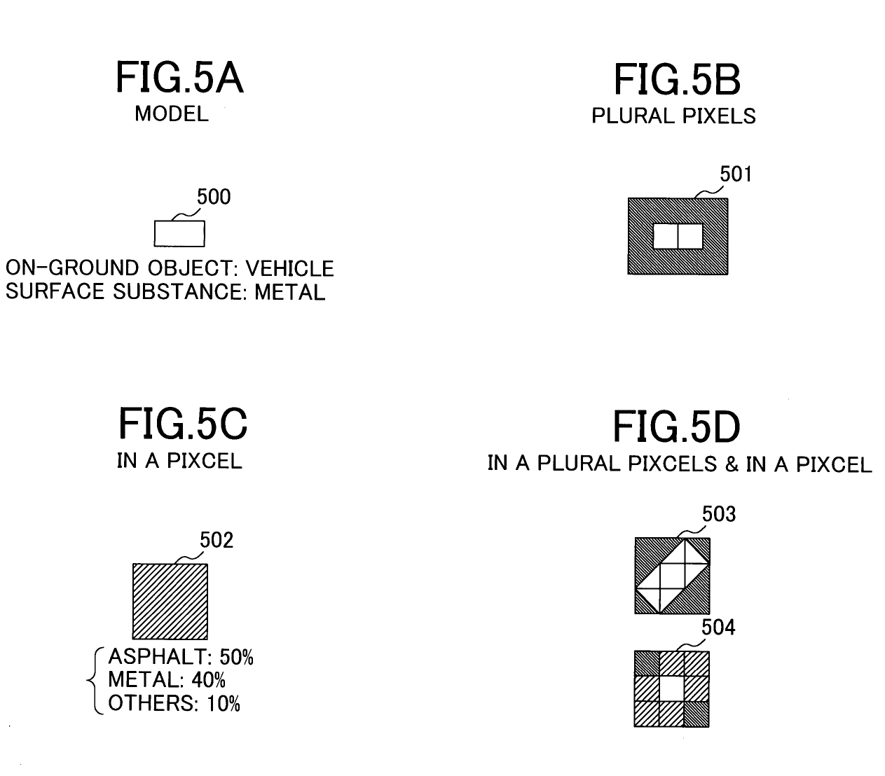

FIGS. 5A, 5B, 5C, and 5D are examples of how to combine a plurality of surface substance information items in the on-ground object analysis performed in the embodiment of the present invention. In the above on-ground object analysis, a plurality of surface substance information items are combined to recognize an on-ground object accurately. FIG. 5B shows an example of observing an on-ground object 500, which is a vehicle shown in FIG. 5A, over a plurality of pixels. In this example, an on-ground object (vehicle) is observed in the center two pixels and asphalt is observed around the on-ground object. And, such target pixels are combined with a plurality of classification results in the peripheral area to make a synthetic determination in broader aspects, thereby enabling the on-ground object existing over a plurality of pixels to be recognized. And, FIG. 5C is an example 502 of observing an on-ground object 500 shown in FIG. 5A as part of a mixel. Even in this case, a plurality of detection results that are asphalt and metal detected in those pixels are combined to enable synthetic determination in which classification results other than the top-ranked result are taken into consideration. Even when the classification result is in the second or lower place, the on-ground object is recognized in detail. For example, peripheral classification results are combined with the classification result to detect the target on-ground object if the existence is highly possible. Recognition by a combination of a plurality of classification results in pixels or those peripheral pixels can be used together with the above method. FIG. 5D is an example in which those have occurred simultaneously. As shown in an image 503 in FIG. 5D, in an image 504 obtained by photographing a model over a plurality of pixels, the plurality of pixels in which both asphalt and vehicle are detected are assumed as mixels that enclose a pixel in which only a vehicle is detected. Generally, small scale on-ground objects are often observed under such circumstances, so that a plurality of classification results in mixels are combined with those in the peripheral area as shown in FIG. 5D to enable a synthetic determination. According to the above combination method, peripheral circumstances are determined synthetically to enable advanced recognition of on-ground objects through knowledge processing, such as narrowing of surface substance/on-ground object candidates and detecting of a target small scale on-ground object hidden in the peripheral spectra.

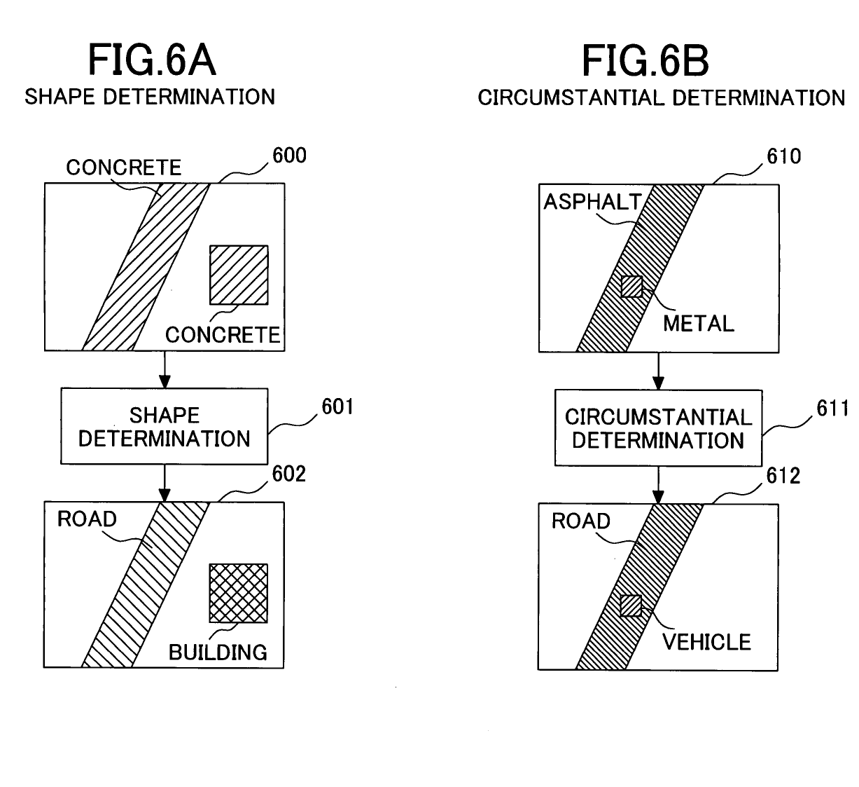

FIGS. 6A and 6B show examples of how to make a synthetic determination in an on-ground object analysis. FIG. 6A shows an example of shape determination. A shape determination result 602 is obtained from the shape determination result 601 and the shape information of each on-ground object included in the on-ground object information so that if the object is long, it is determined as a road and if the object is isolated, it is determined as a building even when the surface substance analytical results 600 denote completely the same concrete. The shape determination can use, for example, area, length, width, and circle measurement techniques in image processes. FIG. 6B shows an example of determination of circumstances. Even when a surface substance analytical result 610 just denotes metal, candidates can be narrowed from the result 612 of the circumstances determination 611 if information of the circumstances under which existence of respective on-ground objects is expected is included beforehand in the target on-ground object information. The circumstances information is, for example, information denoting that a small metal piece of several meters in size is a vehicle while asphalt having a small metal area is a road. In addition to the above method, adjacent determination, inside/outside determination, size determination, space distribution analysis for measuring space circumstances, space filtering for performing decision by majority with respect to each peripheral result, statistical accuracy evaluation of classification of combinations, etc. may also be used.

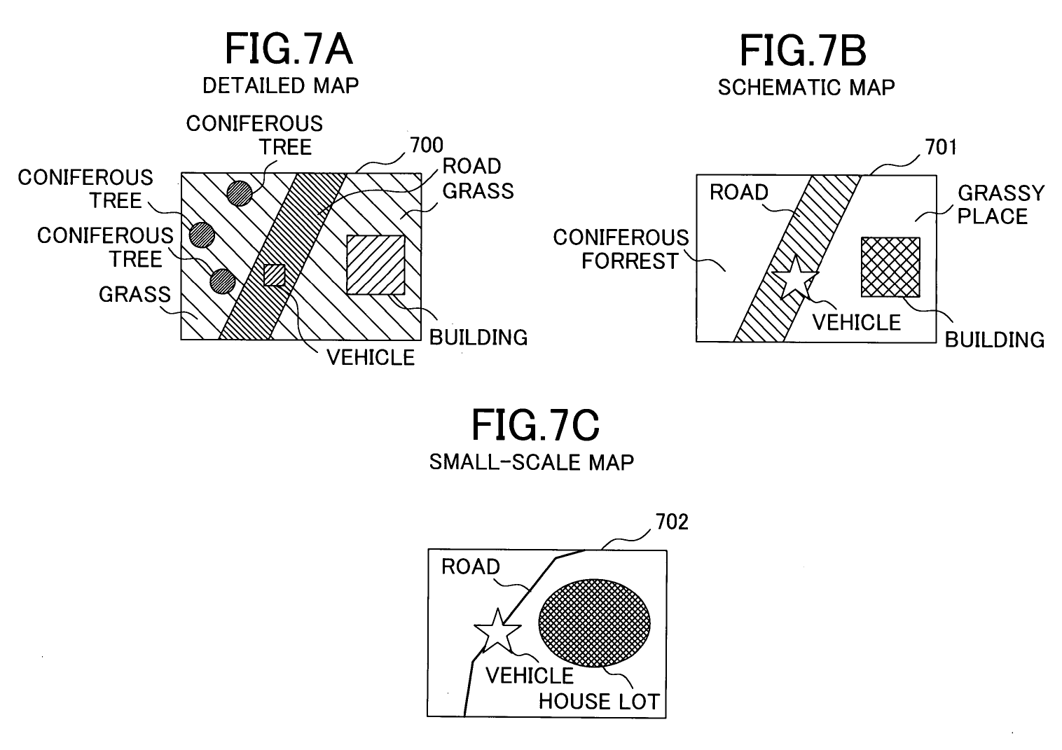

FIGS. 7A, 7B, and 7C show examples of a map output form in the embodiment of the present invention. Detailed surface substance information such as information of each pixel can be used for dynamic representation changes of each on-ground object identification/analytic result on a map according to the output setting at each reduced scale in the on-ground object information setting process to be described later. A detailed map 700 shown in FIG. 7A denotes a large scale level output of on-ground object information, which is made selectively after a collation processing between a surface substance analytical result and on-ground object information. Particularly, the map enables the user to grasp the circumstances of a target place in detail, for example, up to every tree existing there from the multispectral image. A schematic map 701 shown in FIG. 7B denotes the same area as the detailed map 700 output in a medium reduced scale or schematically. The user can obtain area information in detail and easy to understand from the map. In the small-scale map 702 different in reduced scale from that shown in FIG. 7C, the output range of the schematic map 701 is expanded and its abstraction lever is raised. Because characteristics differ among maps, those maps can be used selectively to obtain information efficiently on various levels. The target object emphasis setting to be described later can also be used to output a special target object in an emphasized manner just like the vehicle on the small-scale map 702.

Next, a description will be made for an interface that enables the user to register information in a database, correct registered data in the database, and set necessary values to analyze and display data.

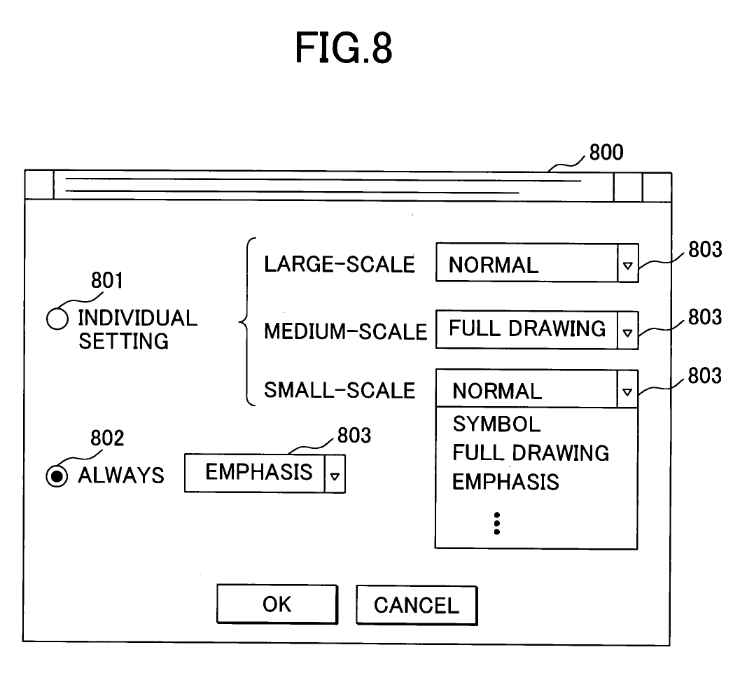

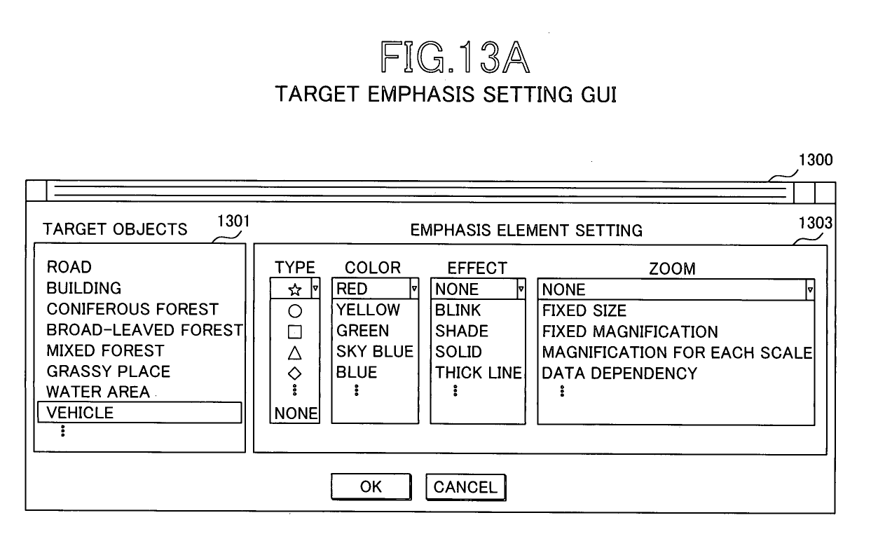

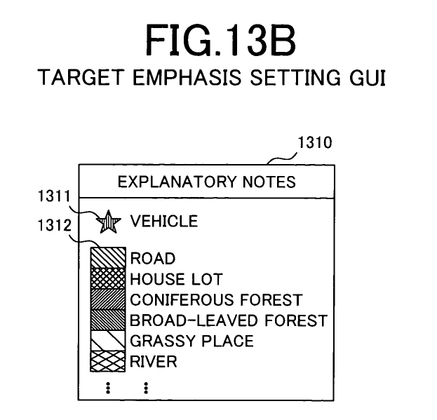

FIG. 8 shows an example of a setting screen corresponding to each of the reduced scale outputs shown in FIG. 7. For example, sometimes the user may want to draw a building normally in a large scale output, but the user may want to draw it together with the house lot (full drawing) in a medium-scale or small-scale output. In the present invention, to set such a user's requirement properly, the system is provided with an output setting GUI 800 for enabling individual setting 801 of such outputs as normal drawing, symbol drawing, full drawing, emphasized drawing, etc. The interface can also accept setting of “full drawing” for a “house lot” concretely. When the user ends necessary data inputs for such setting on this screen, an attribute for deciding a display format in accordance with a reduced display scale display is stored in the target on-ground object information so as to correspond to the on-ground object information. And, because such small-scale on-ground objects as a vehicle are expected to be set so that they are always emphasized in display, the system is also provided with an always-setting 802 for keeping the object displayed regardless of the reduced scale. It is also possible for the user to call the target object emphasis setting GUI shown in FIG. 13 from this GUI to set necessary data for detailed emphasis. As a result, the user comes to create maps easy to recognize and understand target objects, as well as helpful to grasp the circumstances of the target area properly.

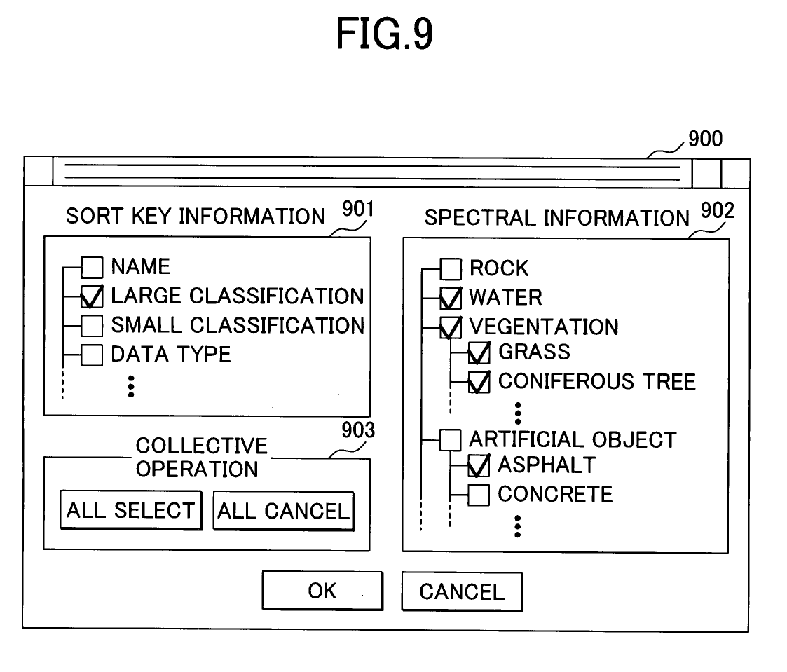

FIG. 9 shows an example of a spectral library selection GUI used in the embodiment of the present invention. If component information is to be registered in any on-ground object information, the information of a surface substance, which is a component, is required to be selected from the spectral library before it is used. In other words, on/off information is required to be set for each spectral information. However, because such a spectral library usually consist of so many spectral information items, there has been expected to have an efficient technique for selecting necessary spectral information from among those information items. And, to meet such a requirement, the present invention has realized a GUI 900 easy to recognize and operate target objects by describing both comment and attribute information for data in each spectral information in the library and sorts and manages the spectral information items in groups and hierarchical layers according to an interpretation method.

For example, items usable for the above interpretation process may include “name” of a surface substance corresponding to each spectral information, “large classification” such as vegetation, man-made objects, etc., “small classification” such as trees, grass, asphalt, concrete, etc., “data creating organization” that has created spectral data, etc. For example, if data items are sorted by “large classification”, the keywords of the large classification are displayed in the field 902. A sorting order is specified so that data is sorted in the optimized order using the GUI 901 provided to select and use such key information as spectral information names, large classification, etc. freely. If data items are to be sorted in a specified order, spectral information items are listed up in a hierarchical structure (step 902) so that the sorting key information is defined as master information while spectral information is defined as slave information. Consequently, the user can recognize spectral information easily. And, because even key information that is master information can be specified selectively, groups and data items in lower layers, which have the same key information, come to be selected/operated collectively. When sorting data items, therefore, only the sequential numbers are sorted while already set on/off information is kept as is. Consequently, a plurality of contents come to be set collectively using their key information.

For example, if the user selects only the spectral information created by a specific data creating organization from among a plurality of vegetation spectral information items, at first all the spectral information items are sorted and displayed on the hierarchical operation GUI screen according to the key information “large classification”, thereby the user is just required to select only one of the master vegetation data items to turn on all the vegetation data items collectively and turn off all the data items except for such vegetation data items as man-made objects collectively. After that, all the spectral information items are sorted again according to the key information “data creating organization”, so that the user is just required to turn off all the data creating organizations except for the target one. The system is also provided with a collective operation GUI 903 for enabling the user to specify selection and cancellation of all spectral information items collectively. With those GUIs described above, the user comes to be able to set necessary data for analyzing object information efficiently and suppressing specification omission. In addition to the on-ground information setting as described above, the operation GUI 7900 can also be called and used as a sub-routine from another processing such as on-ground object information setting, as well as surface substance analysis that uses a spectral library directly. For example, in a surface substance analysis, spectral information can be used selectively using an optimized data set according to the image content, scene state, analysis content, etc. When handling a multispectral image, the user is often requested to operate spectral information. However, this GUI can be used for all those operations of spectral information to standardize the operations in the whole system. As a result, the system is improved to such an advanced one for enabling spectral information to be operated easily and efficiently. While an example for using a tree display interface for displaying data in a hierarchical structure has been described, the interface may be a tabular format interface, as well as such a link-type text interface as the HTML. And, because those setting works require much labor, data that has been set once can be stored in a file so as to be used again to reduce the user's working load. If settings are overwritten with new ones, the reading performance of the system will be improved more and more as the system is used long. Attributes of spectral information may be stored in a file/directory so as to be managed separately from spectral information. A setting file corresponding to attribute information of images and areas to be analyzed may be obtained from the storage means. At this time, the user can analyze object data optimally to the target image/area characteristics without thinking about that specially.

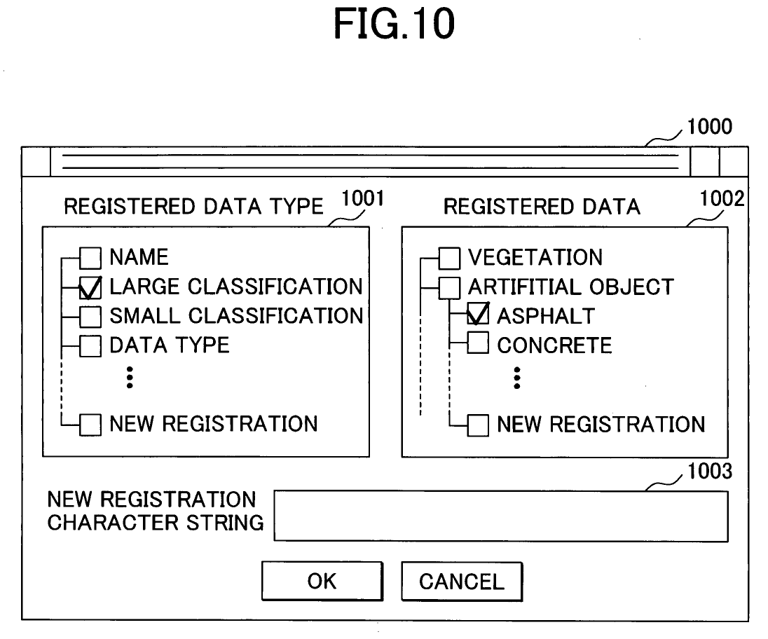

FIG. 10 shows an example of an on-ground object/spectral information registering GUI used in the embodiment of the present invention. As a spectral image analysis goes on, sometimes the user comes to find a new photographed surface substance having no spectral information and/or a new photographed on-ground object having no defined information. To prevent such a problem, the system of the present invention is provided with a GUI 1000 that enables the user to register data more efficiently and the user can use this GUI 1000 to expand/maintain a database while using the system for analyzing information. For example, when setting spectral information corresponding to new on-ground object information, this GUI is called to support the user to register spectral information type and data. If the user selects the registered data type 1001, already registered data 1002 is listed up on the screen according to the selected data type, so that the user is just requested to select target data to be set. For example, when the user is to set road information, the user is just requested to select registered asphalt information. The user can also register new data or data type itself as needed. Because a character string 1003 is inputted for such newly registered data, the user can also register completely new type data.

If there is a spectrum for which no data is registered, the spectrum is read properly under the circumstances and the result is stored in the database, thereby the data is used in and after the next analysis. At that time, the user can register a plurality of types of attribute data; the user can register various types of data, for example, metal as spectral information, vehicle as an on-ground object, fine weather as photographing circumstances, as well as the data registering user name, registering date and time, etc. freely as needed. Consequently, the attribute information can be expanded freely according to the system operation form, user requirement, etc. And, accompanying such expansion of attribute information, the grouping function in the spectral information selection/operation GUI 900 can be expanded. In addition, if respective data items are described clearly, each of those data items is distinguished from not-registered information even when it is used together with the not-registered information in another analysis on another day. The source of each data can thus be shown clearly even if a problem occurs in such mixed use of data. Various type of setting information items described above can be stored so as to be used again in the next analysis, etc. For example, setting information may be stored in a file/directory and/or written directly in the corresponding spectral information.

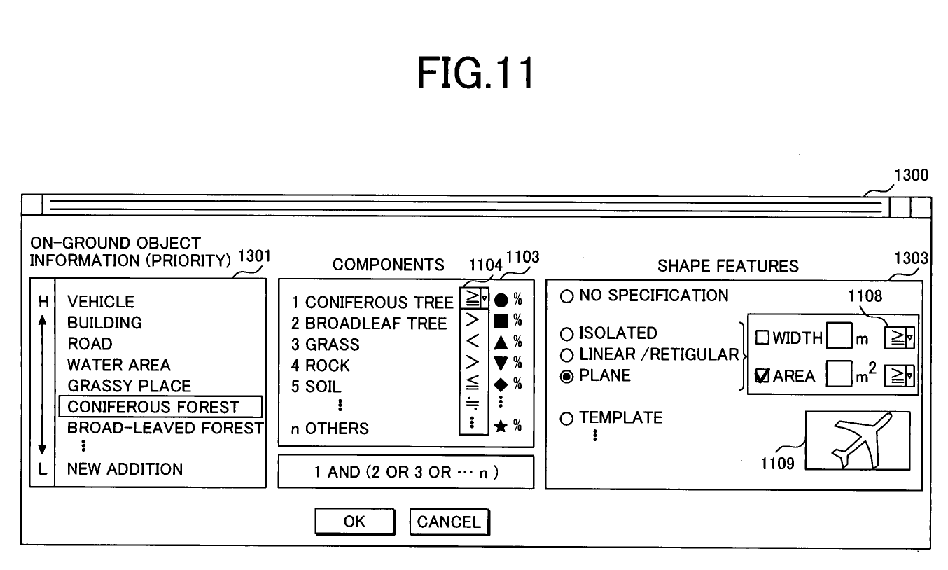

FIG. 11 shows an example of an on-ground object information parameter setting GUI used in the first embodiment of the present invention. The on-ground object information parameter setting GUI 1100 is configured by setting GUIs of on-ground information 1101, and component 1103, shape feature 1106. The on-ground information setting GUI 1101 displays a list of on-ground object information. This GUI 1101 enables the user to correct/register both component and shape feature of each on-ground object information. The on-ground object information setting GUI 1101 displays on-ground object information in order of priority and on-ground objects are identified/analyzed in this order. The display position of each on-ground object on this GUI can be shifted up/down to raise/lower the priority level.

Next, an example of how to correct/register each parameter by selecting a coniferous forest (step 1102) will be described. A surface substance to be recorded in the component 302 shown in FIG. 3 and its composition ratio are registered in the component field 1103. The composition ratio determination/setting can be registered easily as a pull-down GUI 1104. It is also possible to provide an item of “others” to control an amount of each of other surface substances to be mixed. The present invention has also realized a higher general-purpose component registering GUI 1105 for registering the above settings as a logical expression collectively. In this GUI, components are not limited only to surface substances; any information may be selected as a component. For example, such a surface substance group (vegetation, man-made objects, etc.) as a large classification group, and other on-ground objects may be included as components. Consequently, the present invention can realize an advanced GUI that enables the user to set a plurality of surface substances and a plurality of on-ground objects or complicated on-ground information that includes combinations of those items easily and efficiently. When adding or selecting on-ground information, the user can call the spectral library operation GUI 900 shown in FIG. 9 for making efficient operations.

The shape feature setting GUI 1106 registers a type 1107 of an area shape to be evaluated in an on-ground object identification/analysis, which is to be recorded in the shape information 304 shown in FIG. 3. If no specification is made, the shape is ignored to identify/analyze the target on-ground object. If “isolated or linear/reticular” is specified, it is determined whether or not the extracted on-ground object candidate area matches with the specified one in the on-ground object identification/analysis, so that the user can recognize only an area having a proper shape as an on-ground object. At that time, the user can set such parameters 1108 as width, area, etc. for the recognition. If the template 1109 is specified, it is determined whether or not the template is proper for the shape through matching with the input template. Actually, however, matching with such an inputted template is rare, so that the matching check is rather generous; if the shapes almost match with each other, it is determined OK. As described above, the parameter setting GUI 1100 makes it possible to register even complicated on-ground object information efficiently with use of a simple operation system, thereby the user's working load is reduced.

When registering new on-ground object information, the user is just required to give a proper name to the information by selecting the new addition menu. At that time, the user may register any parameters used for analyzing processes, for example, the component and shape information, a threshold value of such a specific index value as a vegetation exponent, as well as a processing flag.

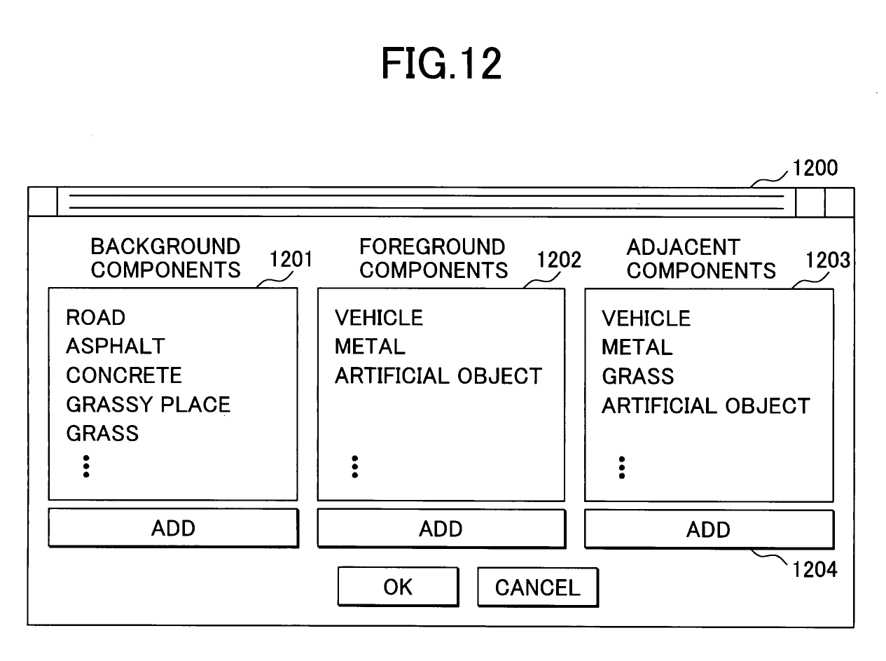

FIG. 12 shows an example of an on-ground object information component combination setting GUI. The set combinations are stored in the combination setting 303 shown in FIG. 3. In some cases, a plurality of component combinations are required to be taken into consideration for on-ground object information. This is why the system is provided with a setting GUI 1200 for arranging components of a target on-ground object into the following three classes; background components, foreground components, and adjacent components so as to register combination information efficiently. In each component registration (step 1204), components to be registered are not limited only to surface substances; selection of every information is allowed as a component. For example, such surface substance groups as surface substances and large classification items, as well as other on-ground objects are allowed to be registered as components here. Consequently, the system can handle complicated on-ground objects, such as a plurality of on-ground objects and a plurality of surface substances or combinations of those components.

Components to be included in the background of a target on-ground object are registered for the background component 1201. In this example, the target on-ground object to be registered is a vehicle. The components can be registered in the order of road, asphalt, etc. so as to recognize the vehicle easily. Components to be included in the foreground of a target on-ground object are registered for the foreground component 1202. In this example, the target on-ground object to be registered is a road. The components can be registered in the order of vehicle, metal, etc. so as to recognize the road easily. Components that are in an adjacent relationship with a target on-ground object are registered for the adjacent component 1203. In this example, the target on-ground object is a vehicle. The adjacent components are registered in the order of vehicle, metal, etc. so as to recognize the vehicle easily. Those settings make it possible to describe recognition rules that include many surface substances, for example, enabling all man-made objects such as metal and glass on the target road to be extracted as vehicle candidates. This is why the present invention can realize the advanced recognition as described above.

FIGS. 13A and 13B show examples of a target on-ground object emphasis setting GUI used in the embodiment of the present invention. This GUI makes it possible to emphasize a target on-ground object visually with respect to other on-ground objects so that the user can recognize the target object easily. To emphasize a target on-ground object, at first the user selects and sets the target on-ground object from the target objects 1301 displayed on the screen of the target object emphasis setting-GUI 1300 shown in FIG. 13A (step 1302), then subjects it to the emphasis element setting process (step 1303). As the target object, not only on-ground object information, but also surface substance information may be listed up. If the user selects a symbol as a type here, the symbol output is emphasized around the extracted area. If the user selects no symbol, the output of the extracted area itself or its frame/line is emphasized. The user is then requested to set emphasis elements. Those emphasis elements are, for example, such effects as color and blink, as well as expansion parameters for expanding the target area according to a fixed magnification and/or output magnification. After that, the target object is output as an emphasized one even when the object is so small that it is removed as noise according to the conventional mapping technique. Therefore, the object is also prevented from reading omission. Such emphasized outputs are also possible not only for images and items on maps, but also for explanatory notes on maps. The explanatory notes 1310 shown in FIG. 13B are output as emphasized ones disposed at the first position so that they catch user's attention more than other items 1312. Such an emphasis processing enables the user to create a customized map according to the user's requirement. The emphasis processing never look over any important on-ground object even when it is wide in range and mass in capacity, enabling the user to grasp detailed circumstances of the target area.

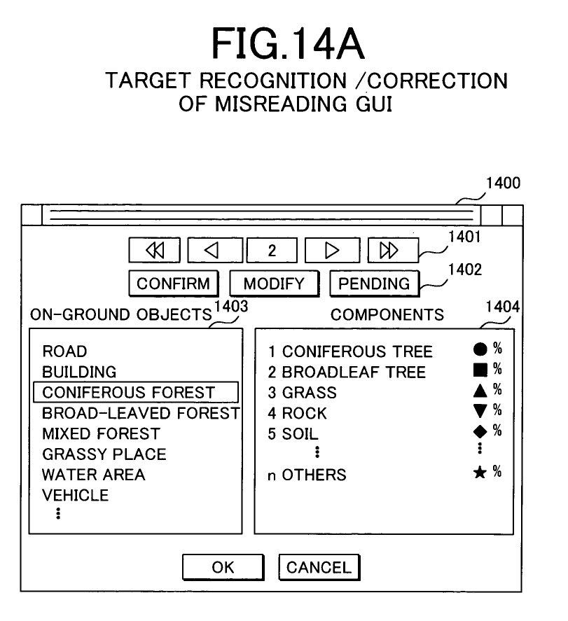

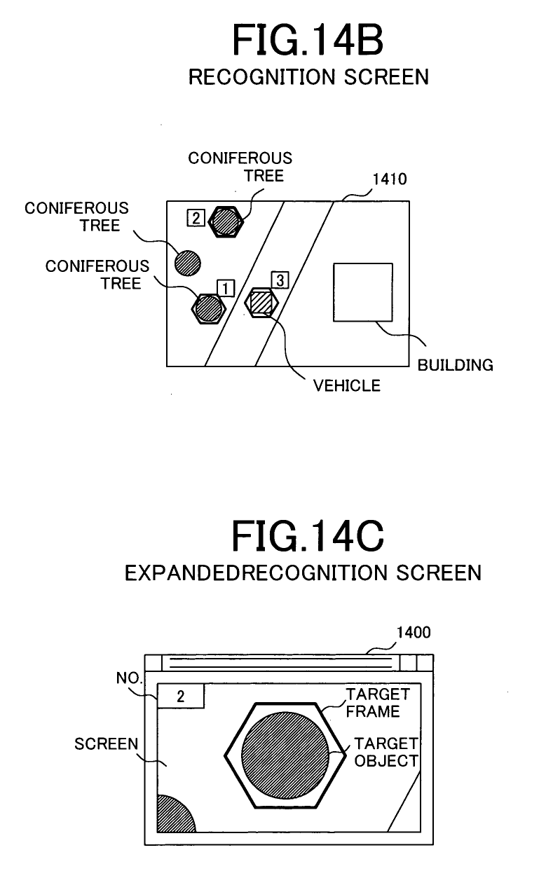

FIGS. 14A, 14B, and 14C show examples of a target confirmation/correction GUI used in the embodiment of the present invention. If a plurality of detection results are obtained from an analysis after a target on-ground object/surface substance is set, they must be confirmed efficiently. And if a reading omission is found, it must be corrected properly. The target on-ground object confirmation/correction GUI 1400 shown in FIG. 14A supports the user to confirm all the target object detection results by displaying them with use of simple navigation GUI 1401 having buttons of “NEXT”, “BEFORE”, etc. The GUI 1400 also provides the user with information of the current target object by displaying on-ground objects 1403 or components 1404 that are analytical results. The user can use those GUIs to correct any on-ground object/component by setting/registering the correct one. On the confirmation screen 1410 shown in FIG. 14B are displayed objects, each to be confirmed with a mark and a unique number. The user can thus confirm the link of the set/registered on-ground object/component with each of the displayed contents of the operation GUI easily at a glance. And, in order to enable the user to know which is the current target detection result from among the displayed ones, only the current target object is output in an emphasized color, blinking, or expanded to be emphasized effectively. As shown in FIG. 14C, the user can also use an expanded confirmation screen 1420 in which an object image is expanded partially. On this expanded confirmation screen 1420, the current target object may be moved to the center of the screen automatically or expanded/reduced into a proper size.

There are three functions usable for the confirmation on this GUI 1400; Confirm, Modify, and Pending. In a case, the user might find a detection result wrong during a visual check of detection results of a target object. At such a time, the user can push the Modify button to register/set the correct on-ground object or component. And, in another case, the user might not be able to be confident of a result of a visual check due to an insufficient resolution or might not be able to determine whether or not an analytical result is correct (since the on-ground object/component is not the expected one). In any of such cases, the user can push the Pending button to skip the confirmation and suspend the decision of whether to register or discard the data. The user can thus cope with both of target object confirmation and correction of reading error, and furthermore to learn processing parameters for suppressing reading errors. With those functions, the system can provide the user with an efficient environment of operations so as to modify the database with use of the analytical result feedback function. The user's load is thus reduced and the system is kept improved in reading functions as it is kept used long. Even when the database construction is still on the way, the user can begin the use of the system with no problem, so that the user can proceed both system operation and database building in parallel.

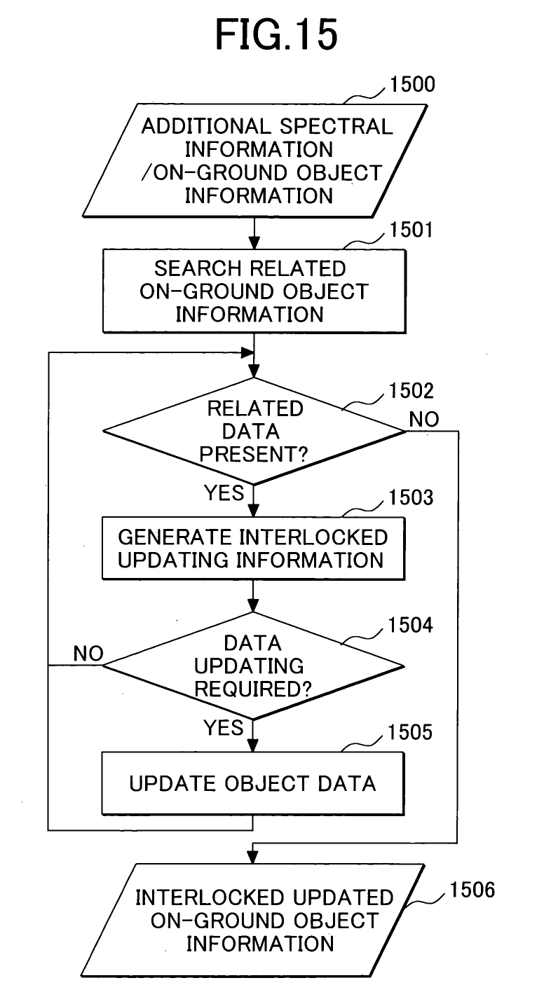

FIG. 15 shows an example of interlocked updating of on-ground object information performed in the embodiment of the present invention. If new spectral information/on-ground object information 1500 is added/registered to/in the system, the user might be required to update various types of existing setting information such as setting of combinations. In the present invention, in such a case, existing setting information is checked to search related on-ground object information (step 1501) upon adding/registering of new data. If there is any related data found (step 1502), interlocked updating information is generated (step 1503) and shown to the user to ask whether to update the information (step 1504). At the confirmation time, the user is just required to confirm whether to update data to be shown sequentially. When the user answers YES for updating any data, interlocked updating is done half-automatically for the data (step 1505), thereby the target on-ground object information is updated (step 1506). For example, if spectral information belonging to a group is added newly to the system, all the on-ground object information items having-spectral information items belonging to the same group and the group itself as components are searched and shown to the user. At that time, the user is just required to answer YES/NO about whether to add the new spectral information to the group. Consequently, each time new information is registered, existing registered information is updated in an interlocking manner. As a result, the system operation efficiency is improved so that the spectral information database or on-ground object information database complicated in structure, consisting of mass of data, and modified by the user almost every day to cope with the user's operation. In addition to the addition of new data, the above method may also be employed to modify existing data, of course.

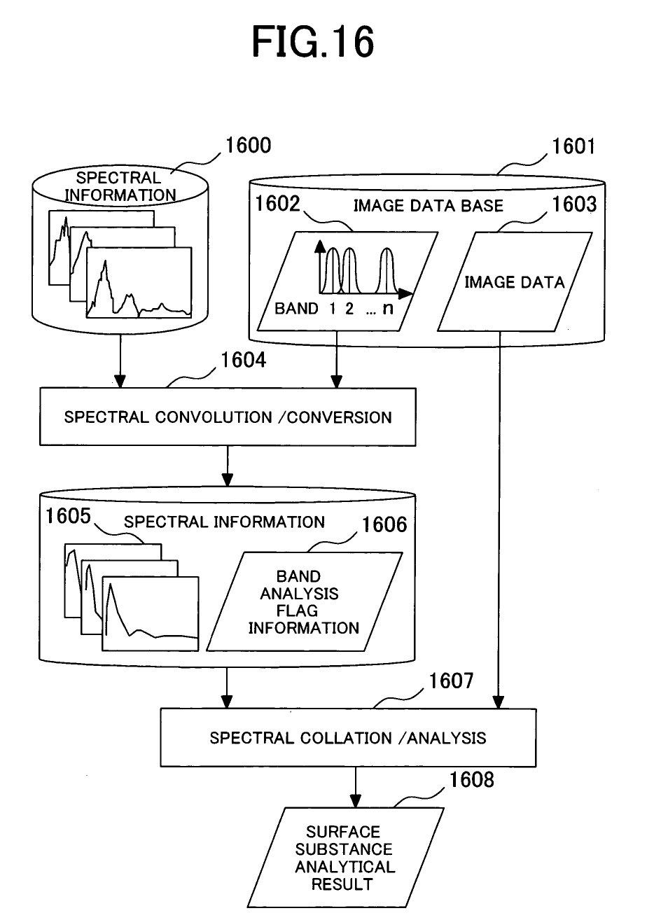

FIG. 16 shows an example of a surface substance analysis performed in the embodiment of the present invention. In the present invention, spectral information is converted to another format data so as to be analyzed and used as needed. For example, it is possible to obtain such sensor characteristic information 1602 as sensor response of a multispectral landscape photographed image used for photographing from an image database 1601 and subject the spectral information 1600 recorded with use of the information 1602 to spectral convolution conversion, thereby calculating both converted spectral information 1605 and band analysis flag information 1606 by taking the sensor characteristics into consideration. The converted spectral information 1605 takes a virtual band configuration 1600 equivalent to that of the image sensor, so that the converted spectral information 1605 and the image data 1603 are used together to make an efficient spectral collation/analysis (step 1607) to obtain a surface substance analytical result 1608. The use of the convolution conversion makes it possible to obtain stable analytical results. The band analysis flag information 1606 is also used to manage such states as “convolution conversion is disabled due to data damages”, “data analysis is disturbed by the atmosphere”, etc. By referring to the flag information 1606, invalid bands can be skipped in analysis, thereby surface substance analysis is made accurately and stably. The flag information may be given automatically in a threshold processing or may be set manually. The flag information may also be stored and managed in a database. The reference to the flag information may also enable images obtained by a discontinuous spectral characteristic multispectral image sensor to be analyzed properly.

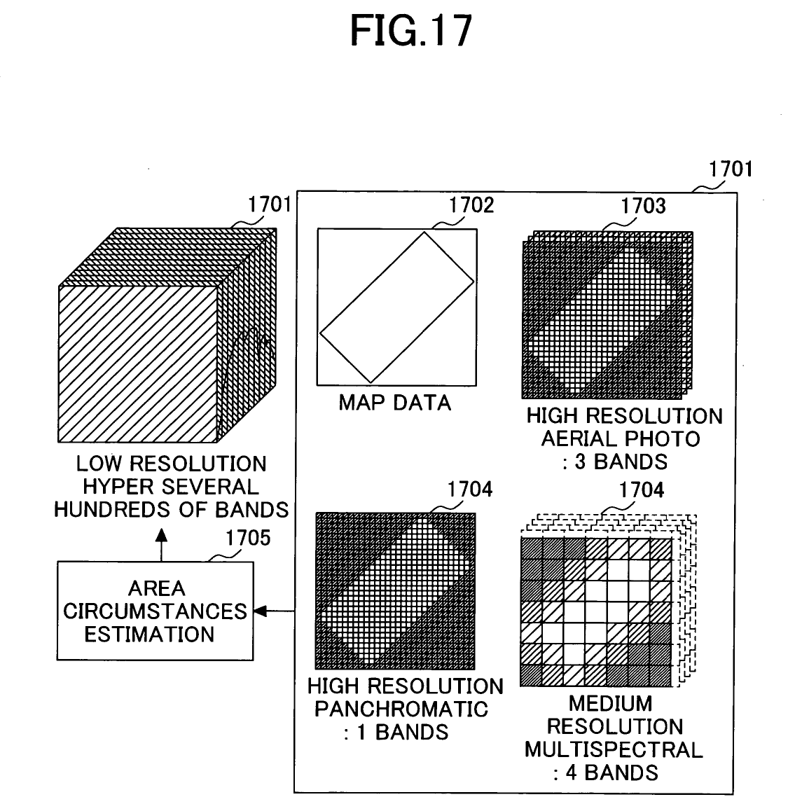

FIG. 17 shows an example of how to combine heterogeneous data items in the embodiment of the present invention. An integral analysis might be required using information other than multispectral images to improve the recognition accuracy. FIG. 17 shows a data image of information in such an integral analysis. The characteristics of the information differs among resolutions and the number of bands. Various kinds of information can thus be obtained by combining those characteristics properly. The heterogeneous data 1701 includes, for example, map information 1702. Synthetic determination is possible as follows, for example. If the target is a road, the circumstances of the target area (road) is estimated (step 1705) according to known items of the map information 1702 to expect existence of a vehicle. In the case of an aerial photo 1703/a high resolution image 1704 obtained from a high resolution man-made satellite, the target area is divided, for example, to extract shape information and color information therefrom and estimate the components and the composition ratio of each component (step 1705) to obtain analytical initial values for high accuracy recognition.

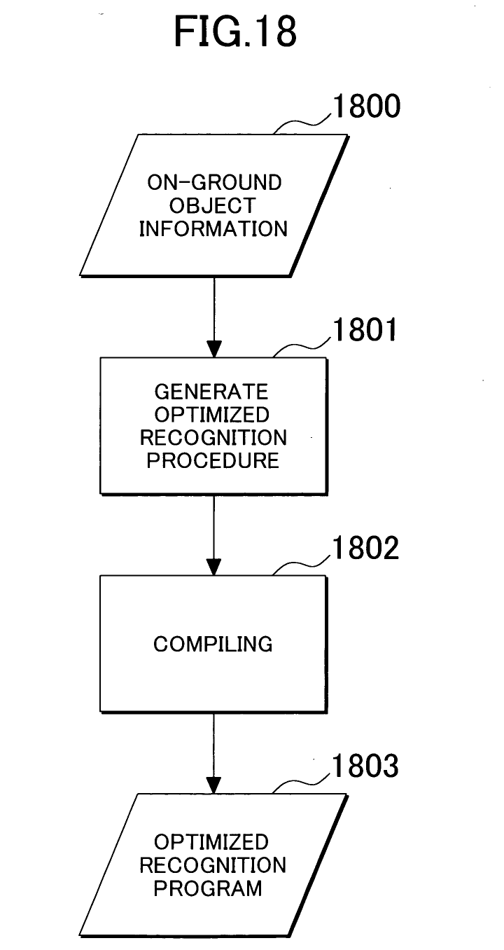

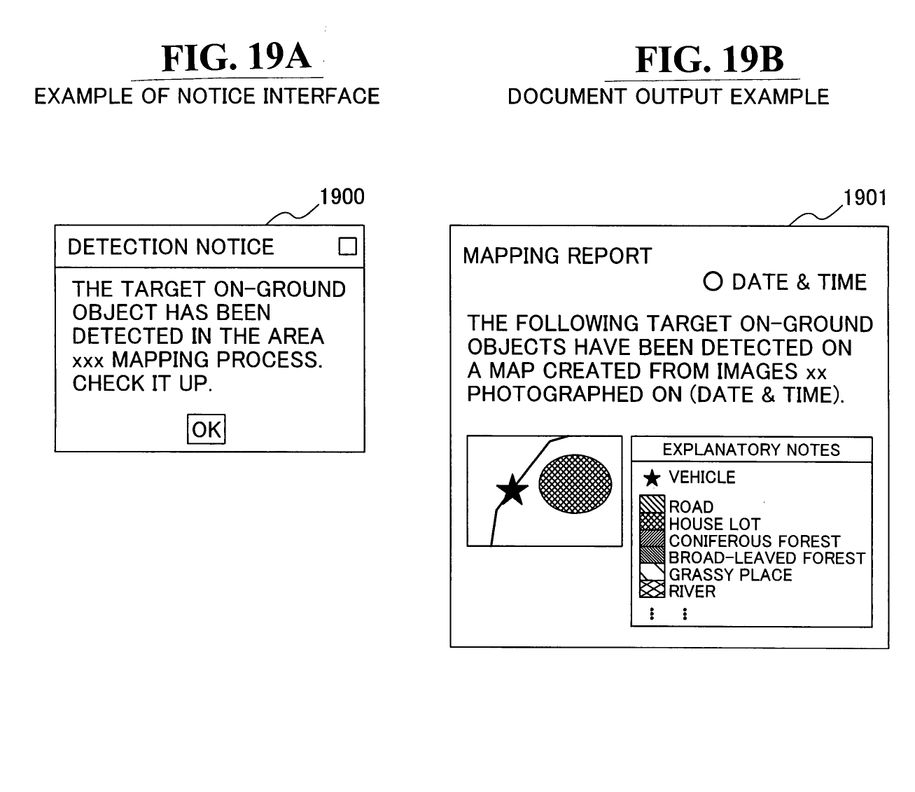

FIG. 18 shows a flowchart for creating an optimized recognition program automatically in the embodiment of the present invention. As the number of on-ground object information items/spectral information items increases, the calculation cost, as well as the recognition processing time also increases. This has been a problem that occurs from the conventional technique. To solve such a problem, the following method is proposed. When specifying a specific on-ground object through an interface to detect the on-ground information 1800, the user calculates an index value, etc. that require less calculation cost and are appropriate to the target on-ground object, thereby the user can recognize only the pixels that are possibly related to the target on-ground object fast; the user ignores other pixels that are not related to the target object. For example, to detect a vegetation area as a target object, the user is just required to calculate a vegetation exponent corresponding to the on-ground object and process the threshold value to limit only the area that is possibly related to the vegetation in the analysis at a fixed order calculation cost regardless of the number of spectral information/on-ground object information items. The method is also effective for a simple case in which the user skips other spectral information that is not related to the target on-ground object. The present invention enables optimized recognition procedures to be generated automatically (step 1801), then compiled (step 1802) into an optimized recognition program 1803. The user can use the program 1803. Consequently, the user can recognize a target on-ground object accurately and efficiently and use multispectral landscape photographed images for various kinds of fields. The user can also receive each detection result as a notice 1900 shown in FIG. 19A or a report 1901 shown in FIG. 19B.

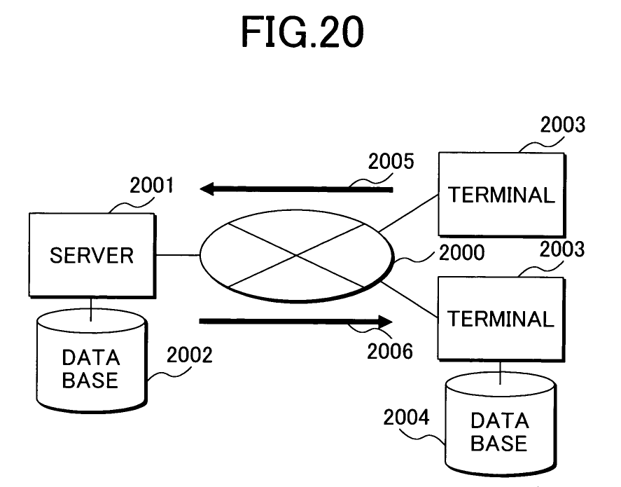

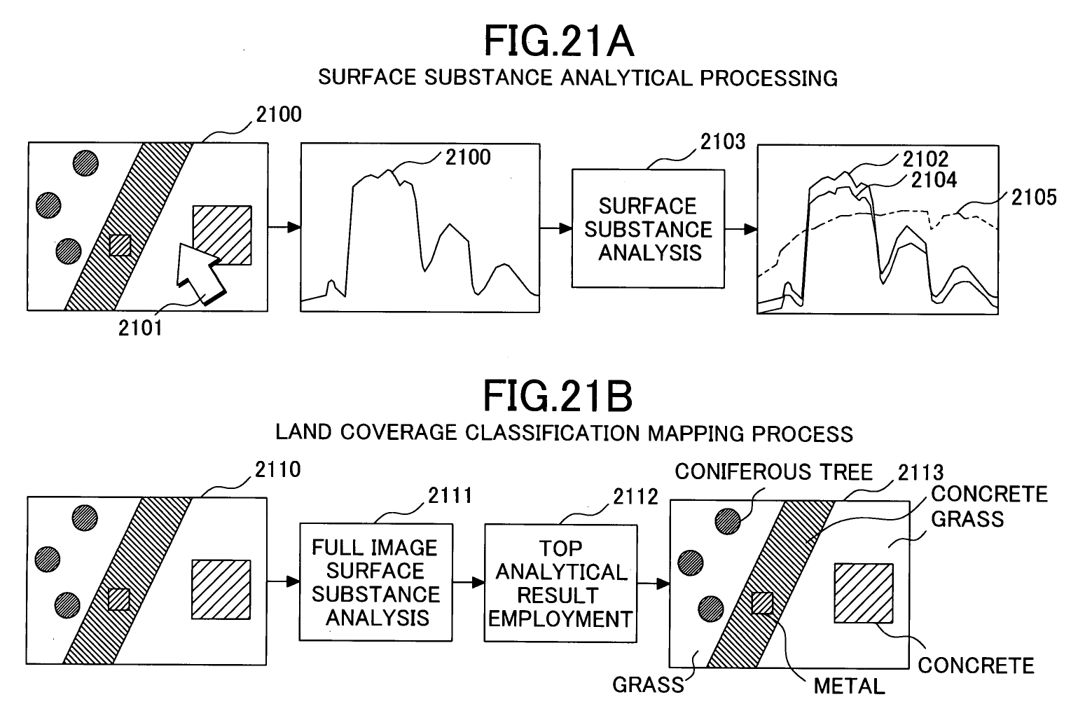

Of course, it is also possible to build a system consisting of one or more terminal devices connected to the photographed image analyzing system of the present invention and provide the input/output/operation process part 100 shown in FIG. 1 with network functions, thereby providing mapping serves. FIG. 20 shows a block diagram of a system for providing such mapping services. The multispectral photographed image analyzing system used as a server 2001 is connected to a network 2000, so that the server 2001 receives an analytical request 2005 from a user terminal 2003 through the network, then executes an analysis in response to the request and returns an analytical result 2006 to the user terminal 2003. In that connection, any of a database 2004 in the user terminal 2003 and a server side database 2002 may be used as a database of on-ground object information, spectral information, or images to be analyzed. Consequently, if the database is maintained/managed at the server side beforehand, the user can obtain necessary information quickly; the user is not required to create any database. In addition, the capacity of data to be sent/received can be reduced, thereby the system comes to be improved in operation and control properties. And, because the user can receive notices 1900, etc. as shown in FIGS. 19A and 19B in addition to mapping services, the map information services come to be diversified. Especially, the system comes to be able to provide high order information services such as target object detection, etc. While how to create respective various types of GUIs has been described so far, those GUIs may also be integrated into a common GUI that operates on a web browser, etc.

According to the present invention, because spectral information of multispectral landscape photographed images is used effectively, on-ground objects can be identified with use of computer even under complicated and diversified circumstances. And, because the present invention enables those objects to be recognized accurately, detailed maps can be created for the objects efficiently to help the user grasp the circumstances of each target area properly. Furthermore, the user's working load and working time required to create those maps, as well as the mapping cost can be reduced. With those effects, the present invention can also apply efficiently even to large capacity multispectral landscape photographed images obtained by photographing a wide range using, for example, a man-made satellite.

What is claimed is:

1. A multispectral photographed image analyzing system, comprising:
an input/output processing unit for inputting a multispectral photographed image obtained by observing a plurality of wavelength bands from the sky;
a spectral information database for storing a plurality of spectral information items;
an on-ground object information database for managing on-ground object information in which each on-ground object corresponds to its spectral information included in said plurality of spectral information items; and
an analyzing unit for analyzing said multispectral photographed image,
wherein said analyzing unit uses said spectral information and said on-ground object information to identify an on-ground object in said photographed image and output the identified on-ground object through said input/output processing unit.

2. The system according to claim 1,
wherein said input/output processing unit displays said identified on-ground object clearly in said photographed image displayed on displaying means.

3. The system according to claim 1,
wherein said on-ground object information database manages information related to the shape of said on-ground object, and
wherein said analyzing unit also uses said on-ground object shape to identify said on-ground object.

4. The system according to claim 1,
wherein said on-ground object database manages information related to the circumstances of the existence of said on-ground object, and
wherein said analyzing unit also uses information related to the circumstances of the existence of said on-ground object to identify said on-ground object.

5. The system according to claim 1,
wherein said on-ground object information database manages a display attribute corresponding to a scale of display on said displaying means with respect to each on-ground object, and
wherein said input/output processing unit, when receiving a specified display scale, outputs said identified on-ground object in a format corresponding to said display attribute that corresponds to said scale.

6. A multispectral photographed image analytical system, comprising:
an input/output/operation process unit for processing an instruction from a user;
a spectral information database for storing a plurality of spectral information items;
an on-ground object information database for managing on-ground information in which each on-ground object corresponds to its spectral information included in said plurality of spectral information items; and
an analyzing unit for analyzing a multispectral photographed image,
wherein said analyzing unit uses on-ground object information corresponding to an identified target object through said input/output/operation process unit to analyze said photographed image and displays an area in which said identified on-ground object is detected on said displaying means.

7. The system according to claim 1,
wherein said input/output processing unit displays an analytical result output from said analyzing units on said displaying means and, when receiving an instruction of correction, updates the information in said on-ground object information database or spectral information database according to said instruction of correction.

8. The system according to claim 1,
wherein said analyzing unit converts information in said spectral information database with use of information related to the characteristics of said photographed image and uses the converted spectral information for said analysis.

9. The system according to claim 1,
wherein said analyzing means further generates a flag for denoting whether to enable the use of a band in said photographed image with use of said information related to said photographing characteristics and controls execution of said analysis according to said flag.

10. The system according to claim 6,
wherein said analyzing means uses on-ground object information of said target object to create a program preferred to detect said target object, then uses said program to make said analysis.

11. The system according to claim 1,
wherein said system is connected to one or more terminals through a network,
wherein said system generates a map through said analysis in response to a request from any of said terminals, and
wherein said system sends a map or information obtained on the basis of said map to said terminal.
